(19) United States
(12) Patent Application Publication
(10) Pub. No.: US 2003/0169238 A1
(43) Pub. Date: Sep. 11, 2003

(54) Computer handwriting tablet equipped with an adhesive writable pad

(76) Inventors: Chia-Jui Yeh, Taipei City (TW); Chao-Wei Tung, Hsinchu Hsien (TW)

Correspondence Address: SUPREME PATENT SERVICES, POST OFFICE BOX 2339, SARATOGA, CA, 95070, US

(21) Appl. No.: 10/094,909

(22) Filed: Mar. 11, 2002

(51) Int. Cl. G09G 5/00

(52) U.S. Cl. 345/173

(57) ABSTRACT

A computer handwriting tablet equipped with an adhesive writable pad is provided with a layer of adhesive pad structure on a writing zone to show off the handwriting locus of a handwriting stylus on the tablet. The layer of adhesive pad structure consists of an adhesive pad layer, a translucent layer, and an anti-scratch protective layer. The adhesive pad layer is formed by laying a sticky film on a plate in dark for covering the top face of the writing zone of the computer handwriting tablet. The translucent layer is a white-foggy plastic sheet for shielding the top face of the adhesive pad layer and the anti-scratch protective layer is in turn placed on the translucent layer for sheltering and protecting the same against scratching.

### BACKGROUND OF THE INVENTION

The existing computer handwriting tablet available in market is found deficient in display of the letters written or curves sketched thereon with a magnetic stylus, namely a user cannot see what he is writing or sketching on the tablet in real time. Instead, he has to lift his head up to see the computer screen from time to time if he wants to make sure whether the word put down on the tablet is correct, which doesn't seem convenient and humanized, particularly to a beginner.

### SUMMARY OF THE INVENTION

The primary object of this invention is to provide an exclusive layer structure capable of showing handwriting locus when writing.

In order to realize the object, a computer handwriting tablet equipped with an adhesive writable pad of this invention is provided with a layer of adhesive pad structure on a writing zone to show off the handwriting locus of a handwriting stylus on the tablet. The layer of adhesive pad structure consists of an adhesive pad layer, a translucent layer, and an anti-scratch protective layer, in which the adhesive pad layer is formed by laying a sticky film on a plate in dark for covering the top face of the writing zone of the computer handwriting tablet; the translucent layer is a white-foggy plastic sheet for shielding the top face of the adhesive pad layer; and the anti-scratch protective layer is in turn placed on the translucent layer for sheltering and protecting the same against scratching.

When a user is writing on the computer handwriting tablet with a stylus, pressure is applied to the layer of adhesive pad structure, such that the translucent layer and the adhesive pad layer are partially and closely depressed together to thereby reveal the color of the adhesive pad layer at the writing locus.

For more detailed information regarding advantages or features of this invention, at least an example of preferred embodiment will be fully described below with reference to the annexed drawings.

### BRIEF DESCRIPTION OF THE DRAWINGS

The related drawings in connection with the detailed description of this invention to be made later are described briefly as follows, in which:

FIG. 1 is a schematic view showing an under-use adhesive writable pad of this invention; and

FIG. 2 is a cutaway sectional view showing the structure of this invention.

### DETAILED DESCRIPTION OF THE INVENTION

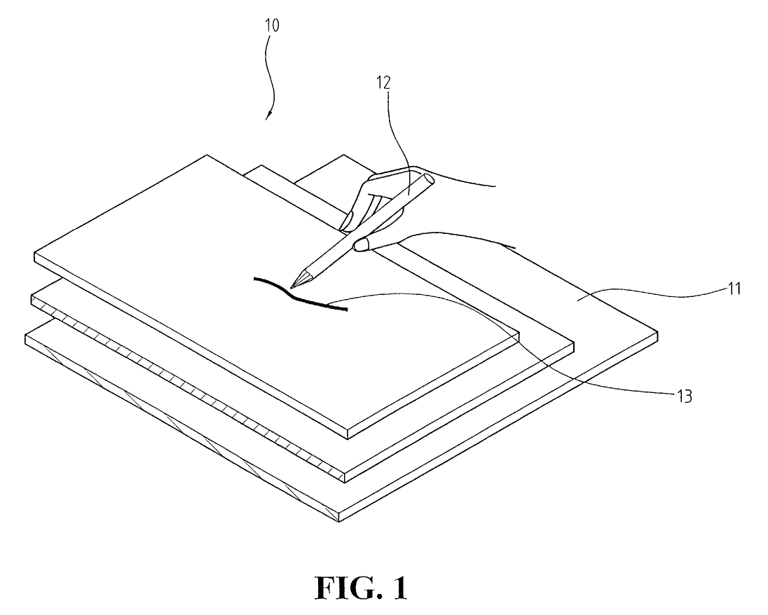

As illustrated in FIG. 1—a schematic view showing a computer handwriting tablet having an under-use adhesive writable pad of this invention—a layer of adhesive pad structure 11 is laid on a writing zone of a computer handwriting tablet 10 to show off the handwriting locus 13 of a handwriting stylus 12 on the tablet.

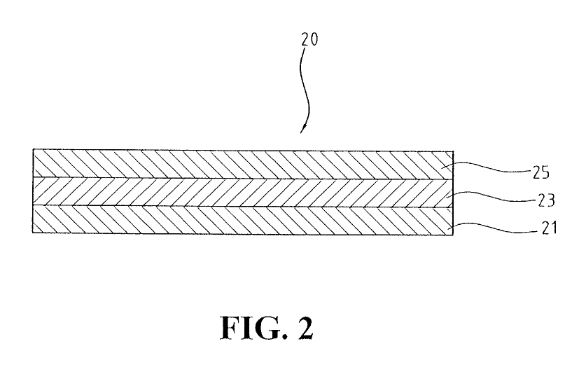

FIG. 2 is a structural cutaway sectional view of FIG. 1. In FIG. 2, a layer of adhesive pad structure 20 consists of an adhesive pad layer 21, a translucent layer 23, and an anti-scratch protective layer 25, in which the adhesive pad layer 21 is formed by laying a sticky film on a plate in dark for covering the top face of the writing zone of the computer handwriting tablet; the translucent layer 23 is a white-foggy plastic sheet for shielding the top face of the adhesive pad layer 21; and the anti-scratch protective layer 25 is in turn placed on top of the translucent layer 23 for sheltering and protecting the same against scratching.

When a user is writing on the computer handwriting tablet with a stylus, pressure is applied to the layer of adhesive pad structure 20, such that the translucent layer 23 and the adhesive pad layer 21 are partially and closely depressed together to thereby reveal the color of the adhesive pad layer 21 at the writing locus.

The anti-scratch protective layer 25 is about 0.1 mm thick made of a transparent Polyethylene Terephthalate (PET) thin film with a low friction coefficient.

The translucent layer 23 is about 0.55 mm thick also made of the PET material.

The adhesive pad layer 21 might be a sticky thick paperboard in thickness about 1 mm, on which a transparent gel is coated on the paper layer to form a thin film, which is then dried to maintain it in a low viscosity.

In the above described, at least one preferred embodiment has been described in detail with reference to the drawings annexed, and it is apparent that numerous variations or modifications may be made without departing from the true spirit and scope thereof, as set forth in the claims below.

What is claimed is:

1. A computer handwriting tablet equipped with an adhesive writable pad, in which a layer of adhesive pad structure is disposed on a writing zone of the handwriting tablet such that the written locus can be revealed in a designated color, in which the layer of adhesive pad structure further comprises:
an adhesive pad layer, which is formed by laying a sticky film on a plate in dark for covering the top of the writing zone of the computer handwriting tablet;
a translucent layer, which is a white-foggy plastic sheet for shielding the top of the adhesive pad layer; and
an anti-scratch protective layer, which is in turn placed on the translucent layer for sheltering and protecting the same against scratching; whereby pressure is applied to the layer of adhesive pad structure when a user is writing on the computer handwriting tablet with a stylus, such that the translucent layer and the adhesive pad layer are partially and closely depressed together to thereby reveal the color of the adhesive pad layer at the writing locus.

2. The computer handwriting tablet according to claim 1, in which the anti-scratch protective layer is made of a transparent Polyethylene Terephthalate (PET) thin film with a low friction coefficient.

3. The computer handwriting tablet according to claim 1, in which the anti-scratch protective layer is about 0.1 mm thick.

4. The computer handwriting tablet according to claim 1, in which the translucent layer is made of PET material.

5. The computer handwriting tablet according to claim 1, in which the translucent layer is about 0.55 mm thick.

6. The computer handwriting tablet according to claim 1, in which a sticky thin film on the adhesive pad layer is formed by coating a translucent gel on the pad layer, then dried to maintain it in a low viscosity.

7. The computer handwriting tablet according to claim 1, in which the adhesive pad layer is a sticky thick paperboard.

8. The computer handwriting tablet according to claim 7, in which the sticky thick paperboard is about 1 mm thick.
